(19) United States
(12) Patent Application Publication
(10) Pub. No.: US 2004/0068606 A1
(43) Pub. Date: Apr. 8, 2004

(54) Method of temporarily deleting and restoring files recorded on a rewritable storage medium

(76) Inventors: Mi Hyun Kim, Seoul (KR); Sung Ryun Cho, Seoul (KR); Byung Jin Kim, (US); Kang Soo Seo, (US); Sung Wan Park, (US)

Correspondence Address: BIRCH STEWART KOLASCH & BIRCH, PO BOX 747, FALLS CHURCH, VA, 22040-0747, US

(21) Appl. No.: 10/464,733

(22) Filed: Jun. 19, 2003

(30) Foreign Application Priority Data
Jun. 19, 2002 (KR) 10-2002-0034277

(51) Int. Cl. G06F 7/00

(52) U.S. Cl. 711/100; 707/100

(57) ABSTRACT

A method of temporarily deleting and restoring files recorded on a rewritable storage medium such as a rewritable optical disk (BD-RW) is disclosed. When a request to delete play list files is received, the play list files are simply marked as temporarily deleted, so that the play list files may be restored later. The method of the invention is capable of easily restoring play list files and relevant clip and clip information files deleted by mistake.

### BACKGROUND OF THE INVENTION

1. Field of the Invention

The present invention relates to a method of temporarily deleting and restoring play list files recorded on a rewritable storage medium.

2. Description of the Related Art

Recently, the standardization for new high-density rewritable optical disks capable of recording high-quality video and audio data for a long time is in rapid progress and products adopting the new optical disks are expected to be commercially available on the market in the near future. The Blu-ray Disc Rewritable (BD-RW) is one of the new optical disks.

FIG. 1 illustrates a schematic diagram of a part of an optical disk apparatus such as a video disk recorder (VDR) that records/reproduces data on/from a storage medium like a BD-RW. The optical disk apparatus comprises an optical pickup 2 for reading recorded signals from a storage medium 1 such as a BD-RW or for recording input data on the storage medium 1, a VDR system 3 for processing the signals received from the optical pickup 2 or for converting an input data stream into a data stream formatted for recording, and an encoder 4 for encoding an input analog signal and outputting the encoded signal to the VDR system 3.

When an A/V stream is recorded on the BD-RW 1 as a clip file, a real play list for playback control of the clip file is created and stored as a file. In FIG. 2, for example, recording Clip 1 A/V stream and Clip 2 A/V stream accompany creating Real PlayList 1 and Real PlayList 2, each of which is stored as a play list file.

A user may select some intervals of the recorded clips and create a play list referencing the selected intervals. Such a play list is a virtual play list (*.vpls). In FIG. 2, Virtual PlayList 1 references Clip 1 A/V stream as a main path and Clip 2 A/V stream as a sub-path because both Clip 1 A/V stream and Clip 2 A/V stream are selected.

To allow a user to select real and virtual play lists recorded on the BD-RW 1, the VDR system 3 of the optical disk apparatus creates a selectable OSD (on-screen display) menu containing the play list information and displays the OSD on a TV connected to the optical disk apparatus, as shown in FIGS. 3a and 3b.

A user, therefore, can select a play list from among all the play lists recorded on the BD-RW 1 through the OSD menu. For example, if a user requests playback of Real PlayList 1, the VDR system 3 performs necessary steps for playing Clip 1 A/V stream referenced by Real PlayList 1.

Similarly, receiving a request to delete Real PlayList 1, the VDR system 3 performs necessary steps for deleting Real PlayList 1.

If a real or virtual play list is deleted by the user's mistake, the deleted play list cannot be restored, which is a problem to be dealt with.

### SUMMARY OF THE INVENTION

In an effort to solve the foregoing needs, it is the object of the present invention to provide a method of restoring deleted play list files, wherein play list files are deleted temporarily and hence the deleted play list files can be restored responsive to a user's request.

A method of temporarily deleting a file recorded on a rewritable storage medium in accordance with one embodiment of the invention comprises the steps of: searching the file table for a file record corresponding to a real play list that is requested to be deleted and recording a mark indicative of temporary deletion and the deletion time in the file record; and finding file records corresponding to the clip file and clip information file associated with the real play list to be deleted, and recording a mark indicative of temporary deletion and the deletion time in the file records.

A method of temporarily deleting a file recorded on a rewritable storage medium in accordance with another embodiment of the invention comprises the steps of: searching the file table for a file record corresponding to a virtual play list that is requested to be deleted; and recording a mark indicative of temporary deletion and the deletion time in the searched file record.

A method of restoring a temporarily deleted file on a rewritable storage medium in accordance with one embodiment of the invention comprises the steps of: receiving a request to restore a real play list temporarily deleted from the storage medium; searching the file table for a file record corresponding to the real play list to be restored, removing the deletion mark from the file record, and recording the restoration time; and finding file records corresponding to the clip file and clip information file associated with the restored real play list, removing the deletion mark from the file records, and recording the restoration time.

A method of restoring a temporarily deleted file on a rewritable storage medium in accordance with another embodiment of the invention comprises the steps of: receiving a request to restore a virtual play list temporarily deleted from the storage medium; searching the file table for a file record corresponding to the virtual play list to be restored; and removing the deletion mark from the file record and recording the restoration time.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a schematic diagram of a part of an optical disk apparatus such as a video disk recorder (VDR);

FIG. 2 illustrates the relations among recorded A/V stream clips, real play lists and a virtual play list referencing the A/V stream clips recorded on a rewritable optical disk (BD-RW);

FIGS. 3a and 3b illustrate menu screens for selecting real and virtual play lists recorded on a rewritable optical disk (BD-RW);

FIG. 4 illustrates the file structure of a rewritable optical disk (BD-RW);

FIG. 5 illustrates the file record including an attribute indicative of temporary deletion in accordance with an embodiment of the invention;

FIG. 6 illustrates a flow diagram of a method of temporarily deleting files in accordance with an embodiment of the invention;

FIG. 7 illustrates a menu screen showing temporarily deleted play lists in accordance with another embodiment of the invention; and

FIG. 8 illustrates a flow diagram of the method of restoring temporarily deleted files in accordance with another embodiment of the invention.

### DETAILED DESCRIPTION OF THE PREFERRED EMBODIMENTS

In order that the invention may be fully understood, preferred embodiments thereof will now be described with reference to the accompanying drawings.

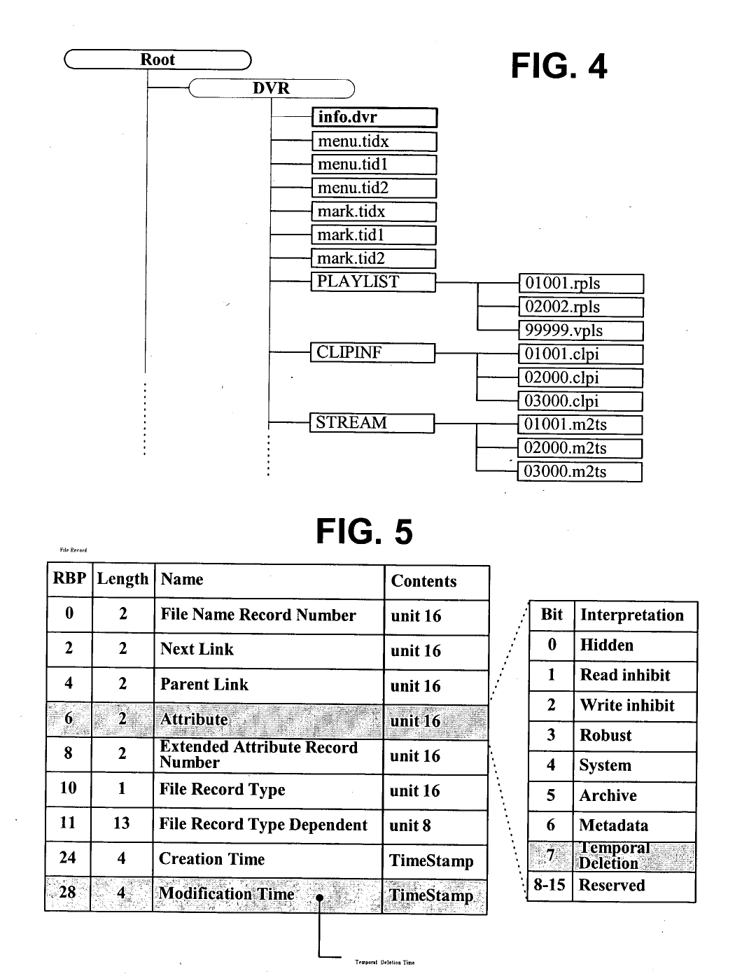

FIG. 4 illustrates the file structure of a BD-RW. The root directory contains at least one DVR directory, which contains files such as ‘info.dvr’, ‘menu.tidx’, and ‘mark.tidx’ and subdirectories such as PLAYLIST, CLIPINF, and STREAM. The PLAYLIST directory contains play list files (*.rpls and *.vpls). The CLIPINF directory contains clip information files (*.clpi). The STREAM directory contains MPEG2-formatted A/V stream clip files (*.m2ts) corresponding to the clip information files.

The playback control information for the stream files stored in the STREAM directory, for example, ‘0101.m2ts’ and ‘02000.m2ts’, are stored in the files ‘01001.clpi’ and ‘02000.clpi’ contained in the CLIPINF directory, respectively.

The play list information for determining continued playback or playback order of the files ‘101001.m2ts’ and ‘02000.m2ts’ are stored in the file ‘01001.rpls’ contained in the PLAYLIST directory.

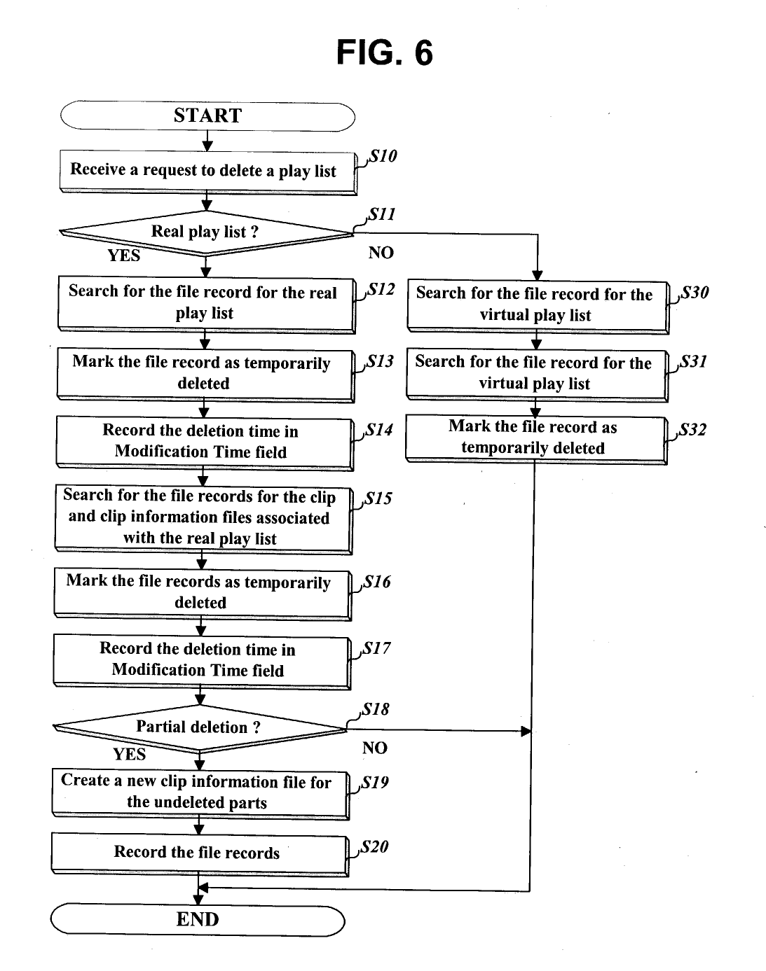

The file table for maintaining the files recorded on the BD-RW includes a plurality of file records, each file record containing the fields of File Name Record Number, Next Link, Parent Link, Attribute, Creation Time, Modification Time, etc, as depicted in FIG. 5. The bit 7 of Attribute field is a Temporal Deletion flag indicating whether the corresponding file record is temporarily deleted.

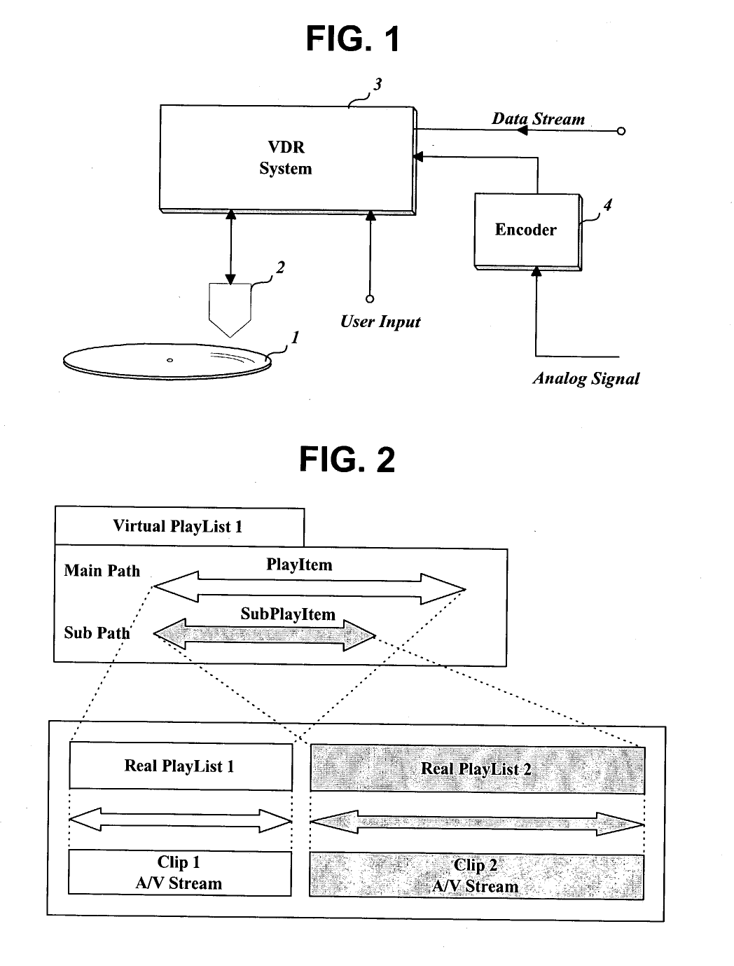

Receiving a request to delete a real or virtual play list, the VDR system 3 of FIG. 1 sets Temporal Delete bit of Attribute field of the file record associated with the play list to ‘1’ to indicate that the play list is deleted temporarily.

When restoring the temporarily deleted play list, the VDR system 3 resets Temporal Delete bit of Attribute field of the file record associated with the play list to ‘0’, which will now be described in detail.

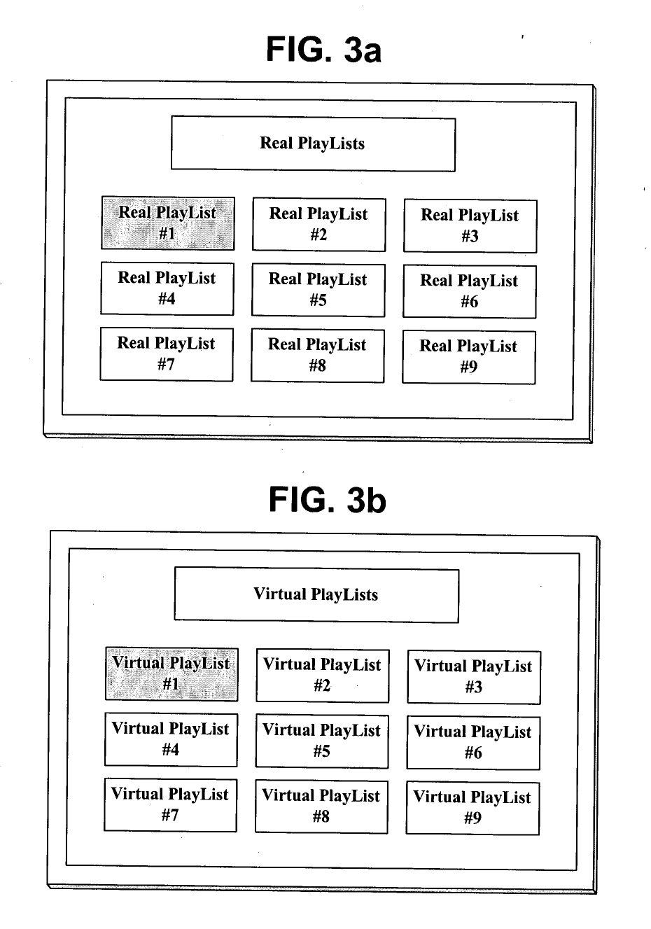

FIG. 6 illustrates a flow diagram of the method of temporarily deleting files in accordance with an embodiment of the invention. When a user selects a real or virtual play list from the OSD menu displayed on a TV screen to delete the play list, as explained above with reference to FIGS. 3a and 3b, the VDR system 3 receives the request for deletion (S10) and examines whether the play list to be deleted is either a real play list or a virtual play list (S11).

In the case of a real play list, the VDR system 3 finds the file record for the real play list (S12) and sets bit 7 of Attribute field of the file record to ‘1’ to indicate that the real play list is deleted temporarily (S13).

In addition, the VDR system 3 sets Modification Time field of the file record to the deletion time (S14). Then the VDR system 3 finds the file records for the clip file (*.m2ts) and clip information file (*.clpi) associated with the temporarily deleted real play list using the information contained in the temporarily deleted real play list (S15).

The VDR system 3 then sets bit 7 of Attribute field of the file record for each of the found clip file and clip information file to ‘1’ (S16) and sets Modification Time field of each of the file records to the deletion time (S17).

If the real play list marked as deleted references not a whole clip file but a part of a clip file (S18), the VDR system 3 marks the clip file as deleted and stores the undeleted part of the clip file as a new clip file on the disk with creating clip information about the new clip file (S19).

Also, the VDR system 3 creates the file records for the new clip file and clip information file by consulting the file records for the deleted files and adds the created file records to the file table (S20).

On the other hand, if the play list to be deleted is a virtual play list, the VDR system 3 searches the file table for the file record for the virtual play list (S30) and sets bit 7 of Attribute field of the file record to ‘1’ to indicate that the virtual play list is deleted temporarily (S31). Also, the VDR system 3 sets Modification Time field of the file record to the deletion time (S32).

In summary, receiving a request to delete a real or virtual play list, the VDR system 3 simply marks the attribute information of the file records for the play list file and the clip file and clip information file associated with the play list file as deleted without actually deleting the files. In this case, the link information contained in file records pointing to the temporarily deleted file record needs to be modified accordingly. For example, if Next Link field of a file record points to the deleted file record, the value of Next Link should be modified in such a way that it points to the file record originally pointed to by the deleted file record.

Because the general techniques for maintaining a linked list can be equally applied to the modification of the link information, the detailed explanation thereof is omitted here.

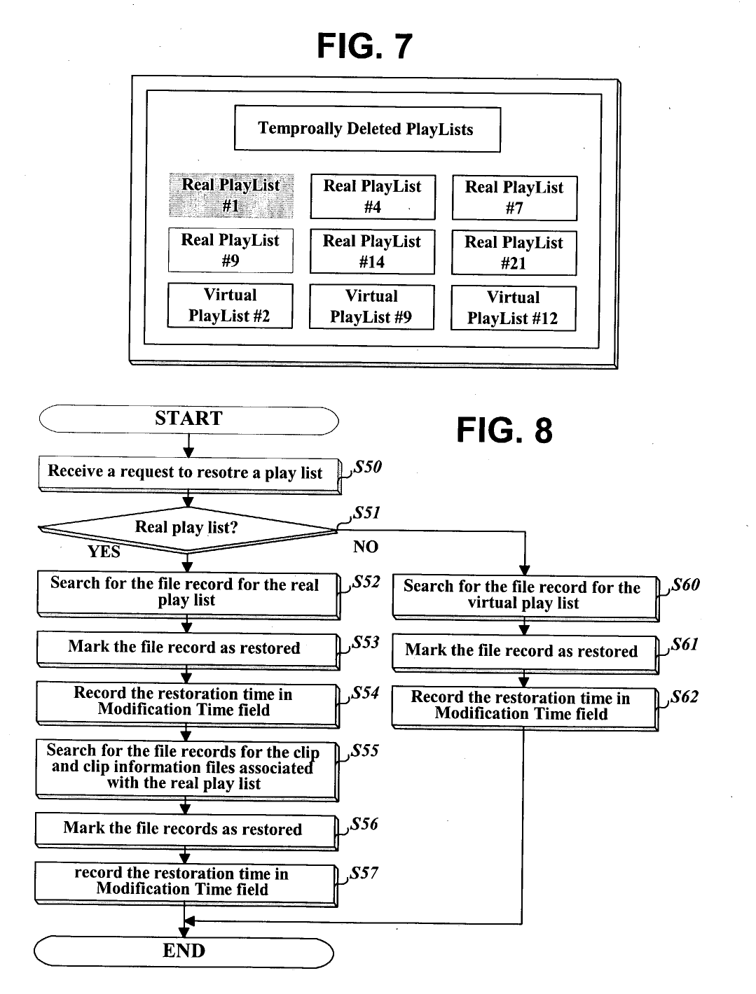

The VDR system 3 can provide the information about temporarily deleted play lists as a selectable OSD menu as shown in FIG. 7 so that a user may select a deleted play list to restore. The method to restore a deleted play list selected by the user will now be described in detail.

FIG. 6 illustrates a flow diagram of the method of restoring temporarily deleted files on a rewritable storage medium in accordance with another embodiment of the invention. After displaying information about deleted play lists, the VDR system 3 receives a request to restore one of the deleted play lists (S50). Then the VDR system 3 tests whether the requested play list is either a real play list or a virtual play list (S51).

In the case of a real play list, the VDR system 3 finds the file record for the real play list (S52) and resets bit 7 of Attribute field of the file record to ‘0’ to indicate that the real play list is to be restored (S53).

In addition, the VDR system 3 sets Modification Time field of the file record to the restoration time (S54). Then the VDR system 3 finds the file records for the clip file (*.m2ts) and clip information file (*.clpi) associated with the restored real play list using the information contained in the restored real play list (S55).

The VDR system 3 then resets bit 7 of Attribute field of the file record for each of the found clip file and clip information file to ‘0’ (S56) and sets Modification Time field of each of the file records to the restoration time (S57). If the restored real play list references a part of a clip file, the VDR system 3 deletes the clip file and clip information files additionally created when the real play list was deleted.

On the other hand, if the play list to be stored is a virtual play list, the VDR system 3 searches the file table for the file record for the virtual play list (S60) and resets bit 7 of Attribute field of the file record to ‘0’ (S61). Also, the VDR system 3 sets Modification Time field of the file record to the restoration time (S62).

In consequence, receiving a request to restore a real or virtual play list, the VDR system 3 resets bit 7 of Attribute field of each of the file records for the play list to be restored and the relevant clip file and clip information file to ‘0’. Also, the link information contained in the file records for the restored play list and adjacent play lists are modified accordingly.

The information indicating that a play list is deleted temporarily may be included in information other than Attribute field of the file record for a play list, for example, in file record type information.

Checking Modification Time fields of temporarily deleted files, the VDR system 3 may permanently delete the temporarily deleted files after a prescribed time duration, for example, 24 hours,

The method of temporarily deleting and restoring play list files recorded on a rewritable storage medium in accordance with the invention provides effective means to easily restore deleted play list files and relevant clip and clip information files.

Although certain specific embodiments of the present invention have been disclosed, it is noted that the present invention may be embodied in other forms without departing from the spirit or essential characteristics thereof. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed is:

1. A method of temporarily deleting a file recorded on a rewritable storage medium, comprising the steps of:
receiving a request to delete a play list recorded on the storage medium; and
marking said play list file as temporarily deleted.

2. The method set forth in claim 1 further comprising the step of marking files associated with the marked play list file as temporarily deleted and recording the deletion time.

3. The method set forth in claim 2 further comprising the step of creating and recording files associated with the undeleted parts of data and creating and recording file records for the created files, if temporary deletion of said play list corresponds to partial deletion of the data.

4. The method set forth in claim 2, wherein said files associated with the marked play list include a clip file containing data to be actually played and a clip information file containing information about the clip file.

5. The method set forth in claim 2, wherein said play list is a real play list referencing a data file, the real play list being created when the data file is recorded.

6. The method set forth in claim 1, wherein the mark indicative of temporary deletion is recorded in an attribute field of a file record containing information about a file of said play list.

7. The method set forth in claim 1, wherein said marking step further records time information about when temporarily-deleted is marked.

8. The method set forth in claim 7, wherein said time information is recorded in a modification time field of the file record containing information about a file of said play list.

9. The method set forth in claim 7, further comprising the step of checking the time information of said play list file marked as temporarily deleted and actually deleting said play list file, if a prescribed time duration has elapsed.

10. The method set forth in claim 1, wherein said marking step searches for related data files by consulting the information recorded in said play list marked as temporarily deleted.

11. The method set forth in claim 1, wherein said play list is a virtual play list created when some intervals of recorded data files are selected by a user.

12. A method of restoring a temporarily deleted file on a rewritable storage medium, comprising the steps of:
displaying play lists having a temporary deletion mark among play lists recorded on the storage medium; and
responsive to a request for restoring one of the displayed lay lists, removing said temporary deletion mark from the play list

13. The method set forth in claim 12 further comprising the step of removing the temporary deletion mark from files associated with the restored play list.

14. The method set forth in claim 13, wherein the play list requested to be restored is a real play list referencing a data file, the real play list being created when the data file is recorded.

15. The method set forth in claim 13, wherein said files associated with the restored play list include a clip file containing data to be actually played and a clip information file containing information about the clip file.

16. The method set forth in claim 12, wherein said restored play list is a virtual play list created when some intervals of recorded data files are selected by a user.

17. The method set forth in claim 12, wherein said removing step records the time of removing the temporary deletion mark in a file record for said restored play list file.
